(19) United States
(12) Patent Application Publication
(10) Pub. No.: US 2015/0008181 A1
(43) Pub. Date: Jan. 8, 2015

(54) WASTEWATER TREATMENT USING CONTROLLED SOLIDS INPUT TO AN ANAEROBIC DIGESTER

(71) Applicant: Bion Environmental Technologies, Inc., Old Bethpage, NY (US)

(72) Inventors: Dominic Bassani, Dix Hills, NY (US); Morton Orentlicher, New York, NY (US)

(73) Assignee: BION ENVIRONMENTAL TECHNOLOGIES, INC., Old Bethpage, NY (US)

(21) Appl. No.: 14/483,424

(22) Filed: Sep. 11, 2014

Related U.S. Application Data
(63) Continuation-in-part of application No. 14/299,898, filed on Jun. 9, 2014.
(60) Provisional application No. 61/832,950, filed on Jun. 9, 2013.

(51) Int. Cl. C02F 9/00

(52) U.S. Cl. CPC C02F 9/00; C02F 3/2813
USPC 210/601

(57) ABSTRACT

The present invention is a system and process for livestock waste management that operates more efficiently than existing technologies with less maintenance and with less chemical process components (and thus chemical handling) with recovery of useful end products. The invention comprises solids separation of the waste to remove solids in excess of about 0.50 mm in size prior to anaerobic digestion followed directly by solids separation preferably using an ultra filter and then ammonia recovery.

### CROSS-REFERENCE TO RELATED APPLICATION

This application is a continuation-in-part of, and claims the benefit of, U.S. application Ser. No. 14/299,898 filed on Jun. 9, 2014, which claims the benefit of U.S. Application Ser. No. 61/832,950 filed on Jun. 9, 2013, each which is expressly incorporated herein in its entirety by reference thereto.

### FIELD OF THE INVENTION

The present invention relates generally to cost effective and easier to maintain waste treatment systems and processes. More specifically, the present invention relates to a system and process to treat and/or manage livestock wastes, including manure, using anaerobic digestion and specific solids handling prior to digestion. The invention can process waste faster than existing technologies, with less maintenance and without post-digestion chemical process components (and thus chemical handling) with recovery of useful end products.

### BACKGROUND OF THE INVENTION

Historically, livestock waste treatment was either free range where manure was intentionally left on the acreage that grew food for the livestock, or controlled where the manure of restricted livestock was collected and land-applied on nearby acreage. The evolution of animal husbandry (particularly the dominant role of concentrated animal feeding operations, “CAFOs”) has separated livestock from the source of their food and concentrated manure in smaller areas separated from the locations where the beneficial components of the manure can be utilized, e.g. as fertilizer, thereby exacerbating adverse environmental impacts of the manure. Further, even when manure is used as fertilizer, fertilization of vegetation is less frequent than the rate at which the manure (waste) is generated. Animals produce waste on a daily basis while vegetation uses the nutrients in that waste on a seasonal basis. In addition, the nutrition of the livestock and the characteristics of the resulting waste rarely match the needs of the vegetation such that if the manure is distributed to supply the nitrogen needs of plants then the manure will typically provide more phosphorus than the plants can use. The excess phosphorous on the land causes severe pollution of ground and surface waters, as well as unpleasant odors and vector attraction.

Regulatory and political pressures increasingly compel farmers to manage livestock manure. Attempts to deal with aspects of manure management in isolation (such as installation of equipment for anaerobic digestion to control odor and vermin) have propagated costly and ineffective projects that burden the farmer financially without resolving environmental issues. Moreover, existing projects and systems typically require use of chemicals and chemical treatment systems that require storage and handling of hazardous chemicals, continuous oversight, constant maintenance, as well as knowledge of inexact sciences and chemistry (e.g., for coagulation and flocculation).

Tightening regulations over the past decades have compelled local governments to expend billions of dollars attempting to control nutrient discharges to the environment. Attempts to force agriculture to pay its share for land and water protection have intensified the pressure on livestock producers to better manage their wastes. Dead zones in the Chesapeake Bay, Gulf of Mexico, and Long Island Sound testify to the continuing pollution of receiving waters from inadequately treated waste.

The technical means to manage livestock manure currently exists, but there is an absence of a process that integrates these technologies in an effective and efficient manner that creates a reliable and cost-effective system.

Technology also exists to capture and dispose of or use the beneficial components of livestock waste. For example, combination of chemical flocculants with centrifuge and filtration equipment will remove both nutrients and solids from the effluent of anaerobic digesters installed at CAFOs. However, the cost, complexity, and operational inefficiencies of those systems discourage their application by farmers making them impractical. The long period of time to achieve treatment using such systems is also unattractive. Less than about three percent of dairy and swine operations in the United States employ anaerobic digesters. Biogas Opportunities Roadmap, Voluntary Actions to Reduce Methane Emissions and Increase Energy Independence, U.S. Department of Agriculture, pp. 17 (2014).

In addition, the match of technology to the specific livestock operation and waste composition is not generally in the repertoire of the equipment vendors for each of the specific technologies applied with the equipment. The actual needs for livestock operations and the resulting waste characteristics and management needs are case specific. Choice of feed, bedding, open lot versus stall, and manure collection methods each produce a different waste composition input to the manure management system. The variations from one location to another and from one day to another makes the design and operation of systems using existing technologies which use chemicals for coagulation and flocculation difficult, certainly more difficult than the typical farmer prefers.

USEPA established AgStar in order to support the livestock industries in attempting to meet some of these costly and complex issues. A report to AgStar (from Preface of A Comparison of Dairy Cattle Manure Management with and without Anaerobic Digestion and Biogas Utilization, J. H. Martin, Jr, AgStar/EPA (Jun. 17, 2004)) stated “[p]ast characterizations of individual process and systems performance frequently have been narrowly focused and have ignored the generation of side streams of residuals of significance and associated cross media environmental quality impacts.” This situation persists and has been noted recently again in Manure Collection and Transfer Systems in Livestock Operations with Digesters, A. C. Lenkaitis, AgStar/EPA, pp. 43 (Mar. 27-29, 2012) in the context of the farm-specific manure-collection systems: “[a]daptation of advanced manure processing requires integration of the manure collection systems to provide a consistent, reliable product.” These and similar reports have pointed to a need for a flexible, integrated approach to the farmer's requirement for a low capital cost, low maintenance, method to eliminate issues of odor and pests, and for compliance with limits on emissions of nutrients (phosphorus and nitrogen, specifically ammonia).

Solid/liquid separation is an operation where at least a portion of the solids component within a viscous material (e.g., liquid or stream) is removed. For manure management systems, solids/liquid separation is typically performed whenever manure is not simply left where it drops. Methods vary from long term storage in lagoons with episodic removal of solids as the lagoon fills, to use of industrial machinery for separation of fiber and other coarse solids from low-solids slurry. These solids separation machines have been developed over generations and many are well suited to the niche markets to which they are applied. For example, some equipment, e.g., a screw press, separates a coarse solids fraction from manure that may be used for animal bedding, compost, or fuel. Other solids separation equipment is used after anaerobic digestion, such as, for example, a screen, centrifuge, or filter, typically with polymer addition in order to capture the intermediary solids and fine solids.

Anaerobic digestion of livestock manure has been practiced for millennia in the form of anaerobic lagoons. Worldwide, this is still the dominant mode of manure treatment, and is still common in the United States. Among the many negative attributes of lagoons for manure treatment are: odor, vermin attraction, ground water pollution and greenhouse gas addition to the atmosphere. Long treatment times and thus large footprints are also disadvantages for these systems. Engineered systems for anaerobic digestion are an improvement and the rule in Europe and for municipal wastewater in the United States, and are increasing in use for livestock manure in the United States. While engineered anaerobic digestion systems greatly mitigate the issues relating to odor and vermin, they may worsen the water pollution issues. This is because the nutrients (phosphorus and nitrogen) are mineralized to a large degree during digestion of manure, and therefore the digestate releases them more effectively to the environment when land applied. In order to prevent this effect it is necessary to introduce digestate treatment systems to capture the nutrients. This involves capture of fine particles on which the phosphorus is concentrated, and treatment of the liquid digestate to capture or destroy the soluble nitrogen.

Although it sounds simple, the removal of phosphorous and nitrogen in sufficient amounts to meet discharge requirements presents many challenges. Compliance with nutrient management requirements motivates capture of fine particles, those smaller than captured in conventional coarse solids separation techniques. Compliance with phosphorus regulations often requires removal of fine particles that contain most of the phosphorus in the manure. In addition, removal and recovery of ammonia and potable water often requires membrane devices that become fouled by the fine particles. Thus, protection of these ammonia removal membranes and effective operation of the ammonia recovery systems requires prior removal of fine solids in the digestate.

Typical operations to remove phosphorous and nitrogen from digestate include additional multi-stage biological treatment processes which require minimum contact times in vessels for treatment (usually also requiring costly aeration equipment) followed by, and/or with, some form of solids/liquid separation for fine particles that use chemical addition for coagulation and flocculation. An air treatment system may also be used (e.g., air stripping) to prevent nitrogen (in the form of ammonia) discharges to the atmosphere. In such systems, the treatment times, the handling and storage of chemicals, and the continuous monitoring and maintenance of the chemical treatment systems present significant challenges to their effective and continuous operation.

Furthermore, variability in digestate characteristics require episodic adjustment of chemical feed rates to achieve optimal coagulation and flocculation rates, adjustments that are often missed or made in an untimely manner causing unreliable coagulation and flocculation results and inefficient usage of chemicals. As a result, existing post-digestion solids/liquid separation processes for removing finer solids from the digestate, including filter presses and the like, are erratic and require maintenance to deal with fouling caused by solids of inconsistent particle size. Overall, these systems are expensive to purchase, install, and operate, and present significant operational difficulties.

Ammonia stripping from wastewater through the utilization of hot air and steam is well established. These methods generally employ industrial acid to capture the stripped ammonia, where normally sulfuric acid is utilized. The utilization of acids is highly effective in both ammonia recovery and in producing a concentrated ammonium salt product. However the stripping methods involve utilization of relatively large and expensive vessels and substantial inputs of thermal and electrical energy to liberate the ammonia. A system that achieves removal of digestate ammonium from particulate colloidal and organic solutes without the expensive equipment and the operational difficulties would be advantageous.

There is a need for a practical manure management technology. There is a need for a waste treatment technology that addresses (1) cost avoidance, such as exclusion of expensive chemicals to capture phosphorus and the associated equipment for those chemicals, and such as equipment for reverse osmosis to capture nutrients prior to discharge of treated digestate from an anaerobic digester, and such as stripper/absorber equipment to capture ammonia; and (2) compliance with existing and anticipated environmental regulations. There is a need for a waste treatment technology that provides a cost effective solution with the conversion of manure to beneficial use materials.

There is a need for an improved manure treatment system that does not utilize expensive, hazardous, chemicals to settle out fine solids and nutrients, chemicals that present significant handling and storage issues. There is a need for an improved manure treatment system that removes fine solids from the waste stream by destroying them instead of costly, and difficult to operate solids removal systems utilizing chemical addition to remove them. There is a need for an improved manure treatment system that operates faster than most existing biological manure waste treatment technologies that also recovers the beneficial components of the waste (e.g., the nutrients) for reuse. There is a need for an improved manure treatment system that effectively removes and recovers nitrogen (in the form of ammonia) without excessive maintenance and oversight.

### SUMMARY OF THE INVENTION

Applicants have invented a new process, system, and method for treating waste that overcomes these and other shortcomings. While the invention will be described in connection with certain embodiments, it will be understood that the invention is not limited to those embodiments. To the contrary, the invention includes all alternatives, modifications and equivalents as may be included within the spirit and scope of the present invention.

Applicants analysis of the particle size distribution and composition of raw and digested livestock manure coupled with the discovery of an anaerobic digester's effectiveness for destruction of fine solids containing phosphorus, has led Applicants to develop a new system and process to treat manure using solids separation, followed by anaerobic digestion followed directly by ultra filters, followed by hydrophilic membranes for ammonia removal. Applicants process does not require sophisticated and complicated equipment and chemicals for coagulation and flocculation to remove phosphorous present on fine solids and Applicants process does not suffer from solids fouling. Applicants process uses a much smaller footprint for anaerobic digestion (about ⅕ the size of a typical anaerobic digester).

Applicants new treatment system and process includes use of solids separation equipment prior to digestion to remove both coarse solids (greater then about 1.0 mm in size) and substantially all of the intermediate solids (between about 0.25 to 1.0 mm in size) greater than 0.50 mm in size, which in turn allows for a greater amount of destruction of the fine solids (less than about 0.25 mm in size) in an anaerobic digester. By controlling the digester input solids particle sizing to below about 0.50 mm, and in some embodiments, which are included in the scope of the invention, below about 0.25 mm, Applicants have discovered the resulting digestate contains a more consistent solids content with significantly less fine solids, particularly less of the fine solids smaller than 0.01 mm in size. The digestate can thus be treated to remove the remaining particulates without chemicals and without coagulation and flocculation and therefore can be treated directly out of the digester using other solids separation equipment, such as an ultra-filter. Moreover, the treated and filtered digestate (digestate with substantially all of the remaining fine solids removed by ultra filtration), having less solids in the waste stream, can then be more easily processed for ammonia recovery, again without fouling from solids.

Knowledge of the size and composition of particles at different stages of manure management has not been considered essential historically. There are a limited number of published studies of the particle size distribution of manure both raw and digested, and composition of the different sized particles. The sparsity of information in this area is a serious gap in our knowledge likely due not only to the failure to appreciate the value of this information but also to the variability of the waste material as it substantially depends on the type of livestock, feed materials, and manure capture methods. Particle size information of the waste has also not been detailed because conventional wisdom has sought to maximize methane production and energy output in the digester. It has been understood and accepted by those of ordinary skill in the art that the output from a digester generally includes fine particulates containing phosphorous that are too small to effectively capture with filters. Rather, those fine solids require coagulation and flocculation for collection and removal.

The limited papers available on the topic agree on the following with regard to raw manure:
1. Coarse solids (greater than about 1.0 mm) content is variable and depends on non-manure content such as used bedding, as well as the coarse solids of the manure. Coarse solids generally range from 40-60% of total solids.
2. Removal of coarse solids has little to no effect on ultimate methane production of the anaerobic digester, but does have a major impact on optimum digester design. Abstract of The Effect of Solids-Separation Pretreatment on Biogas Production from Dairy Manure, K. V. Lo, et al, Agricultural Wastes an International Journal Vol. 8, Issue 3, pp. 155-65 (1983); Abstract of Fixed-film Anaerobic Digestion of Flushed Dairy Manure after Primary Treatment: Wastewater Production and Characterization, A. Wilkie, Biosystems Engineering, Vol. 89, Issue 4, pp. 457-471 (December 2004).
3. Coarse solids hold about 10-30% of the manure phosphorus. Enhanced Solid-liquid Separation of Dairy Manure with Natural Flocculants, M. C. Garcia, et al., Bioresource Technology 100, pp. 5417-23, 5417, 5420 (2009), found that 88% of phosphorus in dairy manure was contained in the fraction that passed through a 250 micron filter.
4. Effective mechanical separation of the fine solids (less than about 0.25 mm) requires use of chemical addition to flocculate small particles.
5. The phosphorus not removed with the coarse solids is in the form of dissolved phosphorus compounds and very fine particles (less than about 10 microns (0.01 mm)). Size distribution and composition of particles in raw and anaerobically digested swine manure, L. Masse, et al, Transactions of the ASAE, Vol. 48(5), pp. 1943-49, 1943, 1947 (2005).

Applicants performed studies to determine both particle size and phosphorus distribution for a dairy cattle manure at different points through a system employing anaerobic digestion treatment. Initial measurements were for Total Solids and Total Phosphorus in raw manure. Results were normalized to the particles below the size passed by a screw press with a nominal 1 mm screen. Applicants discovered that while about 44% of the TS was held back by the 74 micron filter, nearly none of the phosphorus was removed from the liquid. Consistent with other reports, about 70% of the phosphorus passed the 10 micron screen.

TABLE 1
Particle size and phosphorus distribution for raw dairy manure

| Filter size | Fraction of TS | Fraction P |
|---|---|---|
| (microns) | smaller | smaller |
| 1184 | 1 | 1 |
| 74 | 0.568 | 0.995 |
| 20 | 0.321 | 0.772 |
| 10 | 0.220 | 0.679 |

A second comparison was made to determine the influence of digestion on particle size distribution.

Particle size distribution was measured on samples of raw dairy manure and digested dairy manure. As shown in the table below, it was realized that the less than 10 micron fraction of the Total Solids was significantly reduced through digestion, the TS in the less than 10 micron range being about half the value for the raw manure.

TABLE 2
Comparison of particle size distribution of raw versus digested
dairy manure

| | Raw manure | Digestate |
|---|---|---|
| micron range | % in range | % in range |
| 150-200 | 9% | 11% |
| 100-150 | 11% | 16% |
| 50-100 | 15% | 21% |
| 25-50 | 14% | 17% |
| 10-25 | 13% | 16% |
| 0-10 | 38% | 20% |

FIG. 1 is a graph charting the particle size distribution shown in Table 2 above in greater detail for another sample of raw dairy manure filtered through a 300 micron filter. It shows that about 37% of the solids were less than 10 microns in size, and 5.2% were less than 1 micron in size FIG. 2 is a similar graph charting the particle size distribution for digested manure. It shows that for digested manure very fine particles are substantially less prevalent, with 17% less than 10 microns and 1.9% less than 1 micron in size.

FIG. 2 demonstrates that digestion of dairy manure nearly eliminates the sub-micron particles and significantly decreases the fraction below 10 microns which is where 70 percent of the phosphorous lies (from Table 1). This is an unexpected and critical finding because of the existing difficulty and expense arising from fine solids in digestate which must be captured and removed to remove the phosphorus and to prevent fouling of downstream processes. As discussed above, the separation of these fine particles is a source of both expense and complexity for manure management.

Applicants have thus discovered that a manure treatment system/process operating in a manner to increase, preferably maximize, the destruction of fine particles within an anaerobic digester (preferably increase the destruction of the fine particles, particularly destruction of those fine particles below 0.01 mm, greater than in conventional systems) then the treatment of the digestate for phosphorous (and subsequently nitrogen) can be significantly simplified.

Removal of some of the coarse solids and at least some, more preferably substantially all of the intermediate solids greater than about 0.50 mm in size prior to digestion, thus increasing the percentage of solids less than about 0.50 mm in size into the digester, achieves a previously unknown and highly desirable result. The digester operates in a way whereby it selectively destroys a greater amount of the fine particles and about 50 percent more of the fine particles less than 0.01 mm in size. A greater amount of fine solids destruction is achieved through the digester and the particle size distribution of the solids in the digestate is such (i.e., more consistent and with a more desirable solids particle size distribution) that the digestate can be treated immediately and effectively out of the digester with an ultra-filter, and then preferably, followed by an improved ammonia recovery system. A treatment system and process that eliminates the chemicals and equipment needed for coagulation and flocculation for fine particles while including ammonia removal/recovery (e.g., air stripping) is possible. In addition, with a greater percentage of fine solids in the digester input and with the larger, coarse solids that digest at a slower rate removed from the digestion process, a more compact, much higher rate digestion process, with less cost and maintenance, is made possible.

The present invention is a system and process to treat livestock waste that provides a consistent and readily digestible input to an anaerobic digester. This input meets certain criteria using solid/liquid separation unit processes prior to digestion. The digester output according to the invention possesses improved properties including lower total suspended solids, with less fine particles below about 0.01 mm in size, and with less phosphorous bound in fine particles smaller than 0.01 mm in size, that allows for more continuous and practical use of subsequent treatment/removal technologies without the need for chemical addition.

Particles of the manure feed in excess of about 0.50 mm in size contain non-manure material, such as bedding, scraps of wood or plastic, etc., as well as the poorly digestible fibrous material of the manure which decrease the digestion rate for a fixed-film reactor by a factor of two, and contribute little to the conversion of volatile solids to methane. Abstract of The Effect of Solids-Separation Pretreatment on Biogas Production from Dairy Manure, K. V. Lo, et al, Agricultural Wastes an International Journal Vol. 8, Issue 3, pp. 155-65 (1983). According to the invention, the waste is processed for removal of particles greater than about 1.0 mm using a screw press and screens or similar solids separation devices. The resulting treated waste with the larger than about 1.0 mm particles removed are then further treated so that the intermediate solids above about 0.25 to 0.50 mm in size (the larger intermediate solids) are removed through a solids separation process, (e.g., using a screen or the like) creating a stream of relatively uniform and readily digestible waste material which can be fed to the anaerobic digester.

Preferably, the invention uses fixed film digestion which minimizes the capital cost of manure processing by substantially reducing the retention time in the digester for the waste. Whereas a conventional anaerobic digester for livestock requires about 20-30 days of retention time, the digester according to the present invention only requires about 2-4 days. Anaerobic Digestion of Dairy Manure: Design and Process Considerations, A. Wilkie, NRAES-176, pp. 301-312, 304 (Mar. 15-17, 2005). Other forms of digestion including CSTR and plug flow processes using suspended growth are also contemplated and included in the scope of invention.

The system and process according to the invention then uses an ultra-filter or similar device to remove the remaining fine solids in the digestate. Prior to Applicants invention, it has been impractical and ineffective to treat digestate using ultra-filtration directly out of the digester due to the amount of fine solids in the digestate and the fouling issues associated with them. Direct use of an ultra-filter immediately after digestion is a practice not possible prior to this invention due to the operational difficulties arising from the solids (both TSS and solutes) in the digestate which exceed desired design criteria for ultra-filters—the solids in conventional digestate would continuously foul the ultra-filter. According to Applicants invention, on the other hand, with sufficient organic solutes and fine solids destruction in the anaerobic digester, the digestate can be input directly, without further pre-treatment, to a filter device or the like, preferably an ultra-filter. Proper selection of the ultra-filter membrane is still required to capture the majority of the remaining (undigested) phosphorus and fine solids in the digestate, while not generating high power requirements to achieve the required flow rates for economic operation. This selection will depend not only due on the variability of digestate composition, but also with consideration to economic factors such as solids separation cost and the value of the side streams produced.

The invention's resulting ultra-filter permeate contains a low concentration of organic molecules and most of the salts including ammonium ion. If the farm can apply the ammonia-N locally in compliance with its nutrient regulations, then the ammonium can be stabilized with acid and land applied. If the farm wishes to recover ammonia for sale or long-term storage, the permeate can be sent to an ammonia recovery operation.

The permeate from the ultra-filter may be processed using conventional air stripping technologies but more preferably is processed using a higher rate patent-pending hydrophobic-membrane system (U.S. patent application Ser. No. 14/299,898 incorporated herein by reference) to produce an ammonium concentrate. Utilization of hydrophobic membranes to capture the ammonia as technical grade ammonium salt greatly reduces the size and cost negative attributes of conventional ammonia stripping. Fine solids and the dissolved organics destruction in the anaerobic digester protects the ammonia recovery filter, while the remaining capture of solids by the ultra-filter provides the very low solids required for high efficiency performance by the ammonia recovery system.

The filter reject stream from the ultra-filter is a 3 to 4 fold concentrate of the fine solids in the digestate. It is sent to a vacuum filter, rotary filter, or similar device and the solids collected as a cake with high phosphorus content, which would have value either for sale or use locally.

The advantage of the anaerobic digester and overall process operated according to the present invention is the nearly complete destruction of the very fine solids and organic solutes in the digester and an improved digestate, with a materially lower cost than a conventional digester. This is of importance for several reasons including:
These particles sediment very slowly and would otherwise require the use of expensive coagulants and flocculants to be physically removed at a rate consistent with the desired manure processing rate of this system.
Fine solids and organic molecules will readily foul the membrane systems downstream of the anaerobic digester intended for their removal and the removal of excess ammonia. Economical use of such downstream membrane operations is dependent on the efficiency of destruction achieved in the fixed-film digester.

Applicants use of an anaerobic digester in a manure treatment process/system to maximize fine solids destruction through digestion rather than treat the fine solids after digestion is novel for manure treatment systems.

### BRIEF DESCRIPTION OF THE DRAWINGS

The accompanying drawings, which are incorporated in and constitute a part of this specification, illustrate embodiments of the invention and, together with the general description of the invention given above and the detailed description of an embodiment given below, serve to explain the principles of the present invention. Similar components of the devices are similarly numbered for simplicity.

FIG. 1 is a graph charting the particle size results from testing raw dairy manure showing a significant percentage of the solids below 10 microns in size.

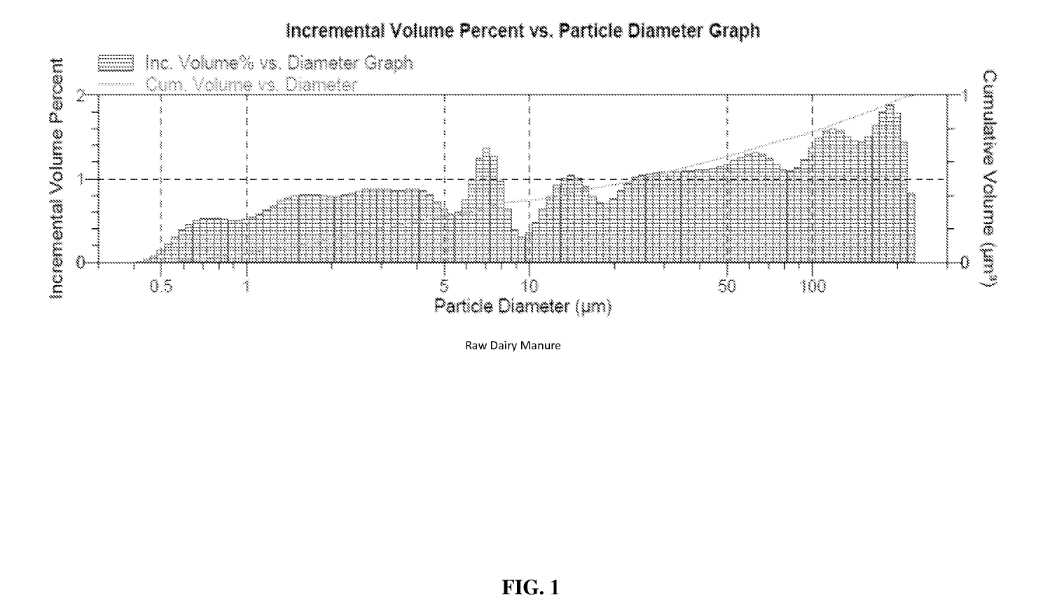

FIG. 2 is a graph charting the particle size results from testing digested dairy manure waste demonstrating that digestion of dairy manure nearly eliminates the sub-micron particles and significantly decreases the solids fraction below 10 microns in size.

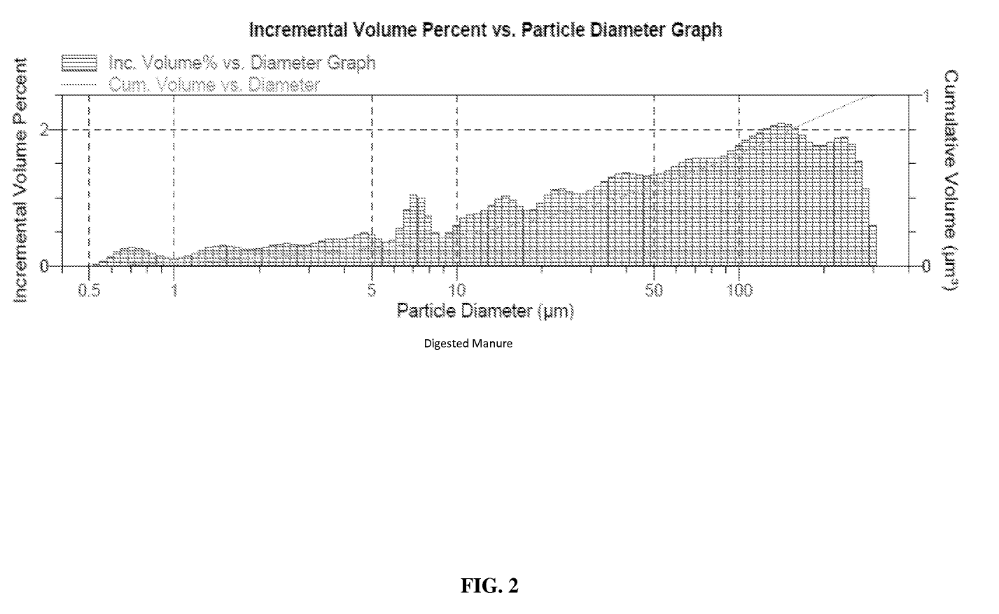

FIG. 3 is a schematic drawing of one embodiment of the invention for the treatment of cattle manure (e.g., from a CAFO) comprising solids separation (two stages) followed by anaerobic digestion, followed by further solids separation, followed by ammonia recovery.

FIG. 4 is a table with values for process parameters for an example system/process according to the invention without a gasifier or third solids separation process for a 1,000 cow CAFO.

FIG. 5 is a table showing values for process parameters for an example system according to the invention with a gasifier and third solids separation process for a 1,000 cow CAFO.

### DETAILED DESCRIPTION OF THE INVENTION

The accompanying drawings, which are incorporated in and constitute a part of this specification, illustrate embodiments of the invention and, together with the general description of the invention given above and the detailed description of an embodiment given below, serve to explain the principles of the present invention. Similar components of the devices are similarly numbered for simplicity.

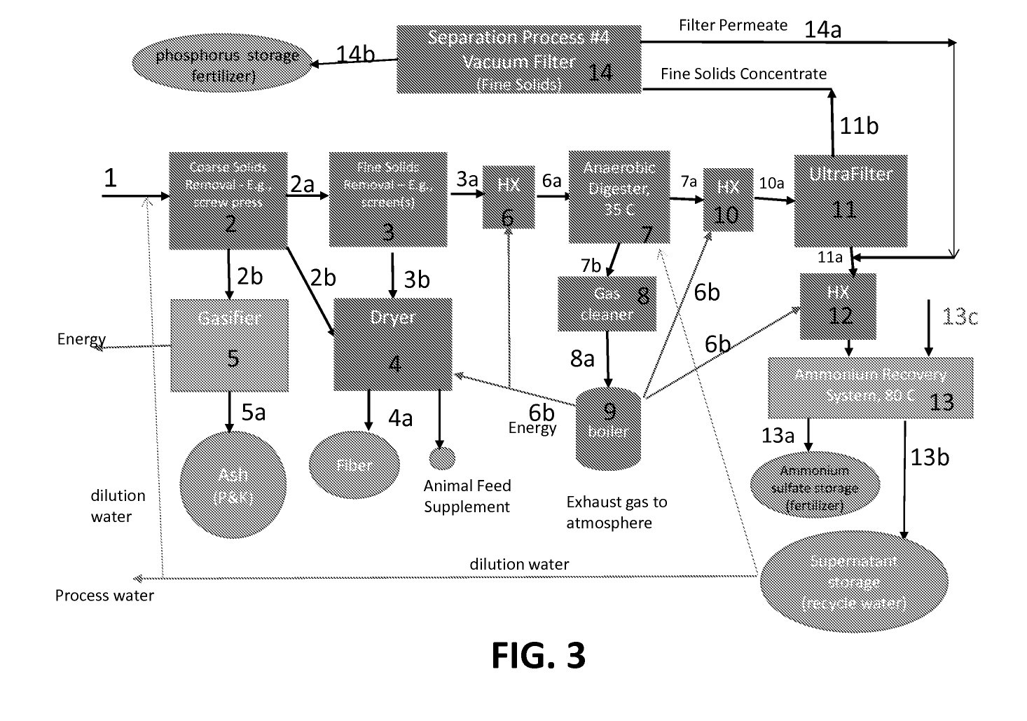

FIG. 3 is a schematic drawing of one embodiment of the invention for the treatment of cattle manure (e.g., from a CAFO) comprising solids separation followed by anaerobic digestion, followed by further solids separation, followed by ammonia recovery.

As depicted in FIG. 3, raw manure with or without associated dairy waste generated at the CAFO 1 is transported to a solids separation process (it being understood that a mixing or holding tank/vessel could be used prior to solids separation). In FIG. 3, the solids separation process is depicted by a coarse solids separation unit 2 (a first solids separation unit) and an intermediate solids separation unit 3 (a second solids separation unit). The output/effluent 2a from the coarse solids separation unit 2 is input into the intermediate solids separation unit 3. Dilution water and/or additional substrates (not shown) can be added to the waste stream in line and/or in a holding tank/mixing pit (not shown) before or after each of the coarse solids separation unit 2 and the intermediate solids separation unit 3. Coarse solids 2b (greater than about 1.0 mm in size) are removed in the coarse solids separation unit 2 and transported to either or both of a dryer 4 and gasifier 5 where the removed coarse solids 2b are dried and/or gasified, respectively. A screw press, for example, can be used as a coarse solids separation unit 2. While actual inputs and controls will dictate waste stream characteristics out of the coarse solids separation unit 2, Applicants expect to see a reduction in the waste stream of about 40 to 60% TS and 15 to 30% phosphorous through the coarse solids separation unit 2. Substantially all of the solids greater than about1.0 mm in size will be removed from the waste.

The output/effluent 2a from the coarse solids separation unit 2 is input into intermediate solids separation unit 3, e.g., a vibrating screen, to remove solids between about 0.50 to 1.0 mm, the larger intermediate solids. While actual inputs and controls will dictate waste stream characteristics out of the intermediate solids separation unit 3, Applicants expect to see a reduction of about 15 to 30% TS and 5 to 15% phosphorous through the intermediate solids separation unit 3 creating a waste stream having about 3.5 to 5.0% TS with particles sizes no greater than about 0.50 mm. In an alternative embodiment, the intermediate solids separation unit 3 is used to create a waste stream having about 3.5 to 5% TS with particles sizes no greater than about 0.25 mm. Solids 3b removed are transported to dryer 4.

Supply of a uniform feed without the less digestible solids which are removed by the coarse solids separation unit 2 and the intermediate solids separation unit 3 allows for operation of a high-rate anaerobic digester (discussed below) that eliminates (destroys) the fine particulates, particularly those below 0.10 mm, and most soluble organic matter, both of which would be prohibitive for later stages of the process according to this invention.

Fixed film anaerobic digestion is a preferred operation in this system due to its several-fold increase in digestion rate relative to conventional digesters, and because the solids separation according to the invention removes larger particles that would otherwise interfere with and damage the fixed-film media. The large particles also take up space in the reactor while adding little to digestible content and increase the power requirements of system pumps. By contrast, the smaller particles and dissolved organics provide immediate food access to the bacteria, and the feed is a low-viscosity liquid with low power costs for pumping and mixing. Feed concentration is controlled by recycle of effluents in the process.

The effluent 3a from the intermediate solids separation unit 3 is input into a heat exchanger 6 where heat 6b generated elsewhere in the process (e.g., boiler 9) is used to raise the temperature of the waste to the required mesophilic temperature for anaerobic digestion, about 35 to 50 degrees Celsius. Note that temperatures herein are approximate values for illustrative purposes only to indicate the approximate demand for thermal inputs of the operations. Dilution water (not shown) can be added before or at the heat exchanger 6 to maintain the required anaerobic digester concentration of organic matter prior to anaerobic digestion.

The output/effluent 6a from the heat exchanger 6 is input into an anaerobic digester 7. Preferably, anaerobic digester 7 is a high-rate, fixed-film digester which digests most of the dissolved organics and small organic particulates to produce a stream 7a appropriate for direct filtration following digestion using an ultra-filter, e.g., less than about 1.5% TSS. Fine solids and dissolved organics destruction in the anaerobic digester 7 creates a digestate with less than about 1.5% TSS (more preferably, less than about 0.8% TSS) having a solids content with less than about 0.25-0.50 mm particle sizes which protects the downstream filtration steps from fouling or clogging which provides influent suitable for the ammonia recovery filter. Concentration of phosphorus-rich solids by the ultra-filter (discussed below) provides the fourth solids separation unit, preferably a vacuum filter (discussed below) feed suitable for production of the high-phosphorus solids product. The anaerobic digester 7 produces biogas 7b containing methane which may be cleaned in a gas cleaner 8 as shown in FIG. 3 (it being understood that the gas cleaner may be removed from the process) to form gas flow 8a that is burned in a boiler 9, providing heat 6b to the heat exchanger 6 for the anaerobic digester 7 and/or the dryer 4 to dry the solids streams 2b and 3b to produce the solid product 4a. Heat 6b may also be directed to other heat exchangers in the process, e.g., 10 and 12. Combustion products are discharged to the atmosphere (not shown).

In a preferred embodiment of the invention including a fixed-film digester 7, the controlled input greatly reduces the hydraulic retention time required for anaerobic digestion of the waste as compared to anaerobic digestion without prior solids removal. Typical farm applications require about a 20 day retention time for conversion of volatile solids to methane gas. Fixed-bed reactors can achieve equivalent performance in 2 to 4 days. Anaerobic Digestion of Dairy Manure: Design and Process Considerations, A. Wilkie, NRAES-176, pp. 301-312, 304 (Mar. 15-17, 2005). High-rate digestion with low-solids input to the anaerobic digester 7 is achieved by immobilizing the anaerobic bacteria in a biofilm on media suspended in the anaerobic digester 7. Effluent from the anaerobic digester 7 is equipped with a screen to prevent the media from being washed out with digestate, and thereby allow a very-high density of bacteria to be retained in the digester 7. The solids removal operations prior to digestion maintain the influent to the anaerobic digester 7 nearly constant, managing variations in manure solids characteristics or concentration.

Relative homeostasis can be maintained by (1) mixing and heating of inputs (e.g., in a reception pit) prior to introduction to the system, (2) control of the solids concentration by addition of dilution water, and (3) removal of solids to eliminate interference from coarse solids and intermediate solids in the digestion operation. Dilution water may also be used to limit the ammonia concentration in the anaerobic digester. In the embodiment of this invention that includes ammonia recovery (discussed below), dilution water may be provided by the low-ammonia effluent from the ammonia recovery operation; and therefore avoid the use of potable water for this purpose. While actual inputs and controls will dictate waste stream characteristics out of the anaerobic digester 7, Applicants expect to see a reduction of about 2% TSS through the anaerobic digester 7 creating a waste stream having about 1.5% TSS. In a preferred embodiment of the invention, for example, a digestate having about 2.5% TS and 1.3% TSS is fed to an ultra-filter with a membrane having a molecular weight cutoff of 5000 Daltons (about a 5 nanometer pore opening size). The resulting permeate would demonstrate 99 percent removal of both TSS and phosphorus by the ultra-filter.

In the embodiment shown in FIG. 3, the effluent from the anaerobic digester 7 is input into a heat exchanger 10 where heat 6b generated elsewhere in the process (e.g., boiler 9) is used to raise the temperature of the waste to about 50 degrees Celsius to meet the preferred temperature for optimum performance of the ultra-filter 11.

The effluent from the heat exchanger 10a is input into a third solids separation process 11, preferably, an ultra-filter. Proper selection of the ultra-filter membrane is required to capture the majority of the digestate phosphorus and very fine solids which hold them, while not generating high power requirements to achieve the required flow rates for economic operation. Destruction of organic solutes and fine solids in the anaerobic digester, and removal of fine solids by the ultra-filter 11, enable the ultra-filter permeate 11a to be treated by the ammonia recovery membranes without rapid fouling. Fine solids and the dissolved organics destruction in the anaerobic digester 7 also protects the ammonia recovery filter (discussed below), while the capture of solids by the ultra-filter 11 provides the very low solids required for high efficiency performance by the ammonia recovery system 13.

While actual inputs and controls will dictate waste stream characteristics out of the ultra-filter 11, Applicants expect to see removal of about all of the suspended solids (a reduction to about 0% TSS if 1.5% TSS is in the input stream) and removal of about 99% of the phosphorous coming into the ultra-filter 11 creating a waste stream having close to 0% TSS with particles sizes no greater than about 0.1 micron, preferably less than about 0.05 microns. The permeate 11a out of the ultra-filter 11 is input into a heat exchanger 12 as described above.

As shown in FIG. 3, the concentrate 11b from the ultra-filter 11 may be sent to a rotary filter or other filter 14, where the permeate 14a would be recycled to the process. The concentrate 11b will be a 3 to 4 fold concentrate of the fine solids in the digestate. A vacuum filtration unit 14 would capture nearly all fine particles of about 1.0 micron or greater size in a cake 14b suitable for drying to make a high phosphorus fertilizer product, and provide a very low solids permeate 14a that may be added to the ammonia recovery input or other point in the process. This operation would reduce phosphorus in the liquid effluent to required regulatory limits, while providing a fertilizer product for beneficial use. The fine solids cake when dried constitutes a high phosphorus fertilizer material and contains about ⅔ of the phosphorus in the input feed 1. This could be blended with the coarse solids 2b to produce a fertilizer rather than a soil amendment, or be sold separately as a high-phosphorus fertilizer material.

If the farm can apply the resulting ammonia-N in the ultra-filter permeate locally in compliance with its nutrient regulations, then the ammonium could be stabilized with acid and land applied. Otherwise, ammonia can be separated and recovered in a high purity, ammonium fertilizer product.

The effluent 12a from the heat exchanger 12 is input into an ammonia recovery system 13. Most preferably, the ammonia recovery system 13 employs hydrophobic membranes for recovery of the ammonia as ammonium sulfate in concentrated form 13a to minimize the costs of storage and transport of the fertilizer product although other ammonia recovery systems, such as, for example, ammonia stripping can be used in the process and are included in the scope of the invention. The ammonia recovery system 13 isolates the soluble nitrogen in a concentrated ammonium liquid 13a, and provides a low-nitrogen liquid stream 13b which can be used as process water in preparation of input to the mixer and the anaerobic digester 7. Ammonia recovery requires addition of sufficient heat to raise the temperature of the permeate to approximately 80° C. in the absence of added alkali, in order to produce ammonia gas from the ammonium ion in digestate, and to promote transport of ammonia gas from the digestate across the membranes in the ammonia removal operation. The membrane unit operation involves dividing the permeate flow into parallel streams, each of which lose approximately 80% to 90% of the NH3-N across the membranes in a hydrophobic membrane module and pumping a continuous stream of acid and ammonium salt countercurrent to the digestate flow through the membrane modules.

At the end of the process, the ammonium salt stream 13a should be stored at a pH of approximately 6 and be nearly saturated with the ammonium salt. The ammonia-depleted digestate 13b (post the hydrophobic-membrane modules) will be a low nutrient stream that may be utilized as process water or be land applied. The concentrated ammonium salt product may be stored as a nitrogen-fertilizer or be crystallized and sold as a commercial solid nitrogen-fertilizer or industrial chemical.

Dissolved NH3-N would be converted to ammonia gas and then captured with sulfuric acid to form a high-purity ammonium sulfate concentrate having about 40 percent by weight ammonium sulfate. This concentrate may be sold to a fertilizer blender or dried and sold as ammonium sulfate crystal. To avoid loss of ammonia to volatilization in an embodiment without the ammonia recovery process, acid (not shown) can be added to the permeate 12a in a mixer tank (not shown) or in line to produce an ammonia fertilizer product with no commercial value but potentially of use on the farm. Depending on both regulatory and agronomic requirements, this product may be directly land applied during the appropriate seasons, or it may be concentrated with a reverse osmosis device (not shown) and applied as needed by the crops.

The ammonium salt stream 13a may be stored at a pH of approximately 6 and be nearly saturated with the ammonium salt. The ammonia-depleted digestate (post the hydrophobic membrane modules) 13b will be a low nutrient stream that may be utilized as process water or be land applied. The concentrated ammonium salt product may be stored as a nitrogen-fertilizer or be crystallized and sold as a commercial solid nitrogen-fertilizer or industrial chemical. It is noted that heat exchanger 10 may not be needed in the process and thus the invention includes embodiments without heat exchanger 10.

In those embodiments of the invention including the gasifier 5, the gasifier 5 is used to produce energy that may be used in the process of the invention and/or at the CAFO. The ash 5a is a high phosphorus and potassium containing material, which may be blended with coarse solids 2b which may elevate the beneficial value of the resulting solids.

The process according to the invention as shown in the embodiment in FIG. 3 provides for energy production and utilization with a gasifier and production of beneficial solids products. In an alternative embodiment, the gasifier and/or the fourth solids separation process can be eliminated and the resulting solids can be land applied at the CAFO or elsewhere. In such an embodiment, adequate thermal energy for internal use is provided by biogas production from the anaerobic digester. Therefore no gasifier is necessary, providing a reduction in capex and also a solid product of composted coarse solids. In addition, nutrients would be used for crop fertilization on the farm's available acreage. Therefore, neither the rotary filter to produce a solid fertilizer (high phosphorus), nor an ammonia recovery system to produce a high NH3-N fertilizer and reusable water, may be needed. This nutrient use would require a permissive Nutrient Management Plan, and availability of water, as well as adequate crop acreage. All effluent streams are suitable for beneficial reuse and none require a disposal expense if the CAFO has adequate crop area to manage nutrients with land application of these streams to local acreage and such a process may have no net energy production.

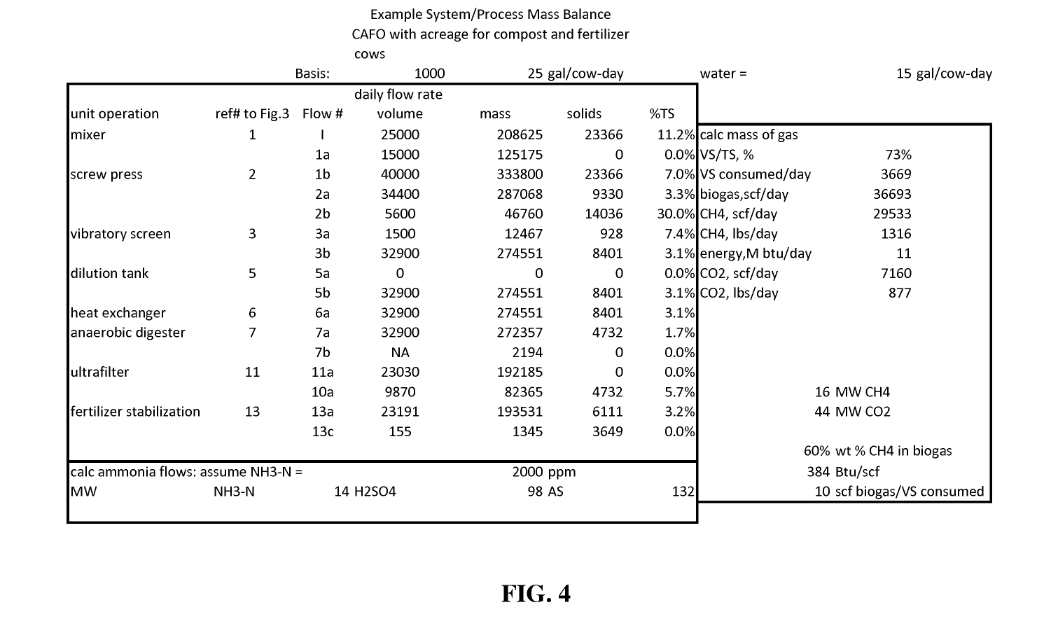

FIG. 4 is a table showing values for process parameters for an example process according to the invention without a gasifier or fourth solids separation process for a 1,000 cow CAFO. Values calculated for sulfuric acid input and mass of fertilizer solution output imply a very dilute ammonium sulfate product containing less than 1% of ammonium-nitrogen. The dilute solution requires large capacity storage lagoons and application of large volumes of fertilization water applied to the crop acreage.

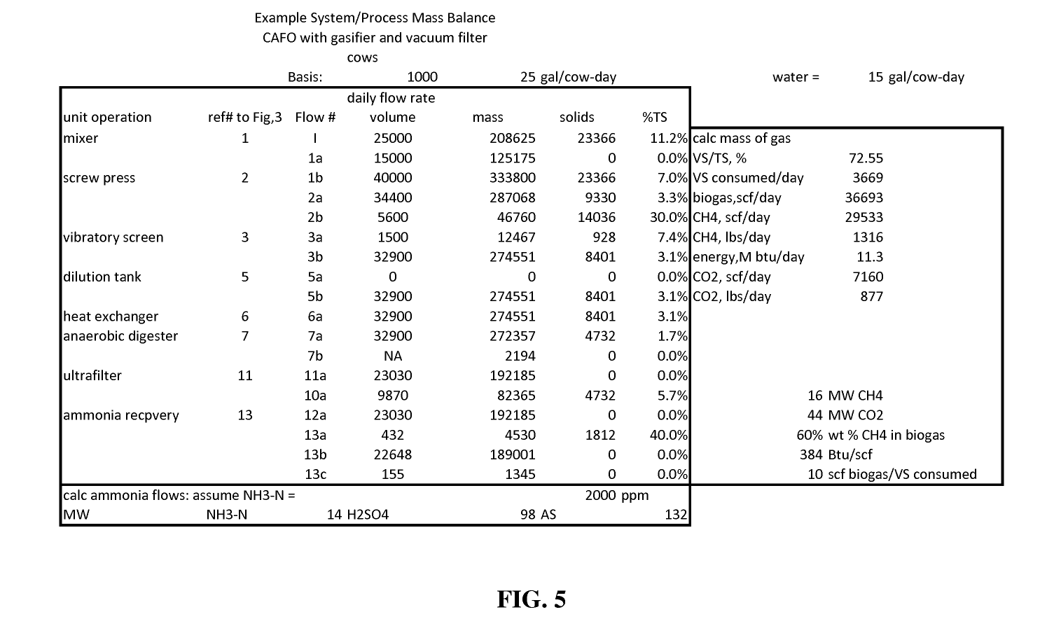

FIG. 5 is a table showing values for process parameters for an example process according to the invention with a gasifier and fourth solids separation process for a 1,000 cow CAFO assuming.

While the present invention has been illustrated by description of various embodiments and while those embodiments have been described in considerable detail, it is not the intention of applicant to restrict or in any way limit the scope of the appended claims to such details. Additional advantages and modifications will readily appear to those skilled in the art. The invention in its broader aspects is therefore not limited to the specific details and illustrative examples shown and described. Accordingly, departures may be made from such details without departing from the spirit or scope of applicants' invention.

We claim:

1. A process to treat manure waste comprising:
treating a collected manure waste stream in a first solids separation unit to remove substantially all coarse solids having particles greater than about 1.0 mm in size creating a first solids separation unit output;
treating the first solids separation unit output in a second solids separation unit to remove substantially all intermediate solids particles greater than about 0.5 mm in size creating a second solids separation unit output;
treating the second solids separation unit output in a fixed film digester wherein particulates in the waste are destroyed creating a fixed film digester output comprising less than about 5.0 percent total suspended solids;
treating the fixed film digester output in a third solids separation unit comprising an ultra-filter without chemical addition for coagulation and flocculation between the fixed film digester and the ultra-filter, wherein a permeate from the ultra-filter results comprises less than about 0.1 percent total suspended solids and less than about 0.1 percent phosphorous;
treating the ultra-filter permeate in an ammonia recovery system comprising hydrophobic membranes with a countercurrent flow of acid and ammonium salt through the membrane, wherein about 80 percent of the ammonia nitrogen is removed from the ultra-filter permeate in the form of an ammonium salt stream;
wherein at least about 99 percent of the phosphorous in said collected manure waste stream is removed by said first solids separation unit, said second solids separation unit, said fixed film digester, and said ultra-filter.

2. The process according to claim 1, wherein less than about 20 percent of the suspended solids in said fixed film digester output are comprised of fine solids less than about 0.01 mm in size.

3. The process according to claim 1, wherein greater than about 50 percent of the solids smaller than about 0.01 mm in size in said second solids separation unit output are removed from said fixed film digester output.

4. The process according to claim 1, wherein said second solids separation unit output comprises less than about 3.5 percent total suspended solids.

5. The process according to claim 4, wherein said fixed film digester output comprises less than about 1.5 percent total suspended solids.

6. The process according to claim 1 wherein said ultra-filter produces a solids concentrate stream having about three times as much fine solids as in the fixed film digester output.

7. The process according to claim 8 wherein said solids concentrate stream is treated in a vacuum filter.

8. The process according to claim 7 wherein the vacuum filter is a rotary filter.

9. The process according to claim 1 wherein retention time in said fixed film digester is between about two to four days.

10. A process to treat manure waste comprising:
removing substantially all coarse solids having particles greater than about 0.5 mm in size from an untreated, collected, manure waste stream;
treating the collected manure waste stream, with coarse and intermediate solids substantially removed, in a fixed film digester wherein organic particulates in the waste are destroyed creating a fixed film digester output comprising less than about 1.5 percent total suspended solids;
treating the fixed film digester output in an ultra-filter creating an ultra-filter permeate comprising less than about 0.1 percent total suspended solids and less than about 0.1 percent phosphorus;
treating the ultra-filter permeate in an ammonia recovery system wherein about 80 percent of the ammonia nitrogen is removed from the ultra-filter permeate; and
wherein at least about 99 percent of the phosphorus in said collected manure waste stream is removed in the process without chemical addition for coagulation and flocculation between the fixed film digester and the ultra-filter.

11. The process according to claim 10, wherein less than about 20 percent of the suspended solids in said fixed film digester output are comprised of fine solids less than about 0.01 mm in size.

12. The process according to claim 10, wherein greater than about 50 percent of the solids smaller than about 0.01 mm in size in said second solids separation unit output are removed from said fixed film digester output.

13. The process according to claim 10, wherein the collected manure waste stream with coarse and intermediate solids substantially removed comprises less than about 3.5 percent total suspended solids.

14. The process according to claim 10 wherein said ultra-filter produces a solids concentrate stream having about three times as much fine solids as in the fixed film digester output.

15. The process according to claim 10 wherein said solids concentrate stream is treated in a vacuum filter.

16. The process according to claim 15 wherein the vacuum filter is a rotary filter.

17. A process to treat manure waste comprising:
removing substantially all coarse solids having particles greater than about 0.5 mm in size from an untreated, collected, manure waste stream;
treating the collected manure waste stream with coarse and intermediate solids substantially removed in a fixed film digester wherein organic particulates in the waste are destroyed creating a fixed film digester output comprising less than about 1.5 percent total suspended solids;
treating the fixed film digester output in an ultra-filter creating an ultra-filter permeate comprising less than about 0.1 percent total suspended solids and less than about 0.1 percent phosphorous;
treating the ultra-filter permeate in an ammonia recovery system wherein about 80 percent of the ammonia nitrogen is removed from the ultra-filter permeate; and
wherein at least about 99 percent of the phosphorous in said collected manure waste stream is removed in the process between the removal of coarse and intermediate solids and the capture of fine solids in the ultra-filter concentrate.
